(19) United States
(12) Patent Application Publication
(10) Pub. No.: US 2023/0278125 A1
(43) Pub. Date: Sep. 7, 2023

(54) LASER BEAM APPLYING APPARATUS

(71) Applicant: DISCO CORPORATION, Tokyo (JP)

(72) Inventors: Teppei NOMURA, Tokyo (JP); Yuki IKKU, Tokyo (JP); Zhiwen CHEN, Tokyo (JP)

(21) Appl. No.: 18/176,600

(22) Filed: Mar. 1, 2023

(30) Foreign Application Priority Data
Mar. 4, 2022 (JP) 2022-033624

(51) Int. Cl. B23K 1/005; B23K 26/08; G02F 1/29

(52) U.S. Cl. CPC B23K 1/0056; B23K 26/083; G02F 1/292; B23K 2101/40

(57) ABSTRACT

A laser beam applying apparatus has a laser beam applying unit including a laser beam source for emitting the laser beam, a spatial light modulator for modulating the laser beam, according to phase patterns, and emitting the modulated laser beam, and a beam focusing assembly for focusing the laser beam modulated by the spatial light modulator and applying the focused laser beam to a plate-shaped workpiece. The laser beam applying apparatus also has a controller including a phase pattern storage section for storing a plurality of phase patterns representing respective different positions in a plane of the plate-shaped workpiece where the laser beam is applied when the phase patterns are displayed on the spatial light modulator, and a phase pattern control section for switching to predetermined phase patterns among the phase patterns stored in the phase pattern storage section as the phase patterns displayed on the spatial light modulator.

### BACKGROUND OF THE INVENTION

### Field of the Invention

The present invention relates to a laser beam applying apparatus.

### Description of the Related Art

One known laser beam applying apparatus for applying a laser beam to an object is disclosed in JP 2021-102217A, for example. The laser beam applying apparatus has a laser beam source that generates a laser beam. The laser beam from the laser beam source is modulated by a spatial light modulator and then focused onto the object by an objective lens. When the laser beam applying apparatus disclosed in JP 2021-102217A is to change an area of the object that is to be irradiated with the laser beam, it uses scanning means such as a galvanoscanner or a micro electro mechanical systems (MEMS) scanner as irradiated-area changing means for changing the area to be irradiated.

### SUMMARY OF THE INVENTION

However, the scanning means incorporated in the laser beam applying apparatus tends to make the laser beam applying apparatus structurally complex and increase the size of the laser beam applying apparatus. Another approach to change the area to be irradiated is to move a processing table on which the object is placed. However, this approach is problematic in that it takes some time to move the processing table. The distance by which the processing table is moved may be reduced by an attempt to increase the area to be irradiated. However, since the level of laser beam power applied to the spatial light modulator is limited in view of the light resistance of the spatial light modulator, the attempt is practically infeasible because a required laser beam power density cannot be achieved in the increased area to be irradiated.

It is therefore an object of the present invention to provide a laser beam applying apparatus that is capable of realizing high productivity with a relatively simple apparatus structure.

In accordance with an aspect of the present invention, there is provided a laser beam applying apparatus including a holding table for holding a plate-shaped workpiece thereon, a laser beam applying unit for applying a laser beam to the plate-shaped workpiece held on the holding table, and a controller for controlling the laser beam applying unit. The laser beam applying unit includes a laser beam source for emitting the laser beam, a spatial light modulator for modulating the laser beam emitted from the laser beam source, according to phase patterns, and emitting the modulated laser beam, and a beam focusing assembly for focusing the laser beam modulated by the spatial light modulator and applying the focused laser beam to the plate-shaped workpiece. The controller includes a phase pattern storage section for storing a plurality of phase patterns representing respective different positions in a plane of the plate-shaped workpiece where the laser beam is applied when the phase patterns are displayed on the spatial light modulator, and a phase pattern control section for switching to predetermined phase patterns among the phase patterns stored in the phase pattern storage section as the phase patterns displayed on the spatial light modulator. The laser beam is able to two-dimensionally scan the plane of the plate-shaped workpiece when the phase pattern control section switches between the phase patterns displayed on the spatial light modulator.

Preferably, the laser beam applying apparatus further includes a moving mechanism for moving the holding table and a focused spot of the laser beam relatively to each other.

Preferably, the plate-shaped workpiece includes a board with a plurality of semiconductor chips mounted thereon with bumps interposed between the board and a surface of each of the semiconductor chips, and the phase patterns stored in the phase pattern storage section include phase patterns such that, when the phase patterns are displayed on the spatial light modulator, the positions where the laser beam is applied as represented by the phase patterns indicate respective regions corresponding to the semiconductor chips on the board. The laser beam is able to two-dimensionally scan a plane of the board in regions corresponding to the semiconductor chips to reflow the bumps included in areas irradiated with the laser beam, when the phase pattern control section switches between the phase patterns displayed on the spatial light modulator.

Preferably, the beam focusing assembly is provided by a focusing function of the spatial light modulator.

The above and other objects, features and advantages of the present invention and the manner of realizing them will become more apparent, and the invention itself will best be understood from a study of the following description and an appended claim with reference to the attached drawings showing a preferred embodiment of the invention.

### BRIEF DESCRIPTION OF THE DRAWINGS

FIG. 1 is a perspective view illustrating a structural example of a laser beam applying apparatus according to an embodiment of the present invention;

FIG. 2 is a perspective view illustrating by way of example a plate-shaped workpiece to be irradiated with a laser beam by the laser beam applying apparatus illustrated in FIG. 1;

FIG. 3 is an enlarged fragmentary cross-sectional view of the plate-shaped workpiece illustrated in FIG. 2;

FIG. 4 is a diagram illustrating a structural example of an optical system of the laser beam applying apparatus illustrated in FIG. 1;

FIG. 5 is a perspective view illustrating the manner in which a laser beam modulated by a first phase pattern is focused onto the plate-shaped workpiece;

FIG. 6 is a perspective view illustrating the manner in which a laser beam modulated by a second phase pattern is focused onto the plate-shaped workpiece;

FIG. 7 is a perspective view illustrating the manner in which a laser beam modulated by a third phase pattern is focused onto the plate-shaped workpiece;

FIG. 8 is a perspective view illustrating the manner in which a laser beam modulated by a fourth phase pattern is focused onto the plate-shaped workpiece; and

FIG. 9 is an enlarged fragmentary cross-sectional view of the plate-shaped workpiece illustrated in FIGS. 5 and 6.

### DETAILED DESCRIPTION OF THE PREFERRED EMBODIMENT

A preferred embodiment of the present invention will be described in detail hereinbelow with reference to the accompanying drawings. The present invention is not limited to the details of the embodiment described below. The components described below cover those which could easily be anticipated by those skilled in the art and those which are essentially identical to those described below. Further, the arrangements described below can be combined in appropriate manners. Various omissions, replacements, or changes of the arrangements may be made without departing from the scope of the present invention. In the description below, those components that are identical to each other are denoted by identical reference characters.

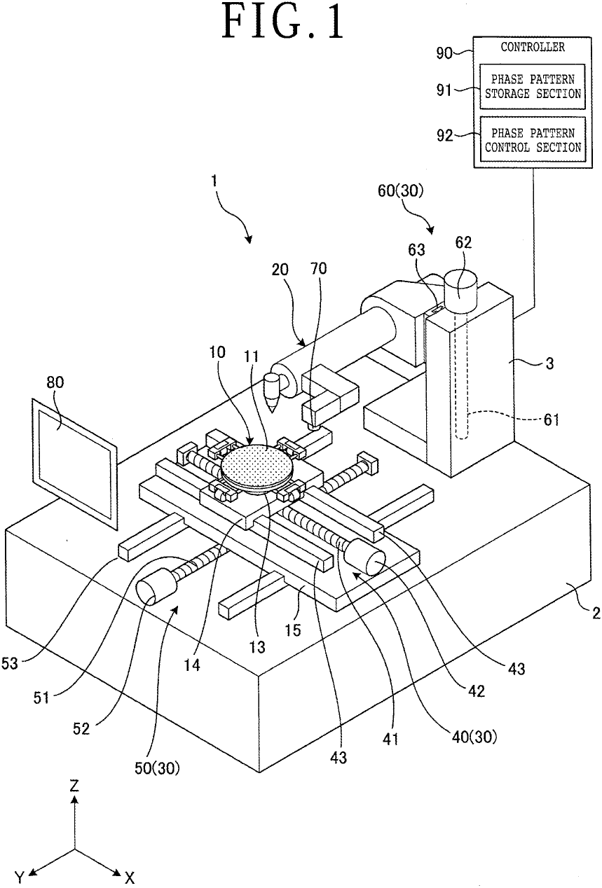

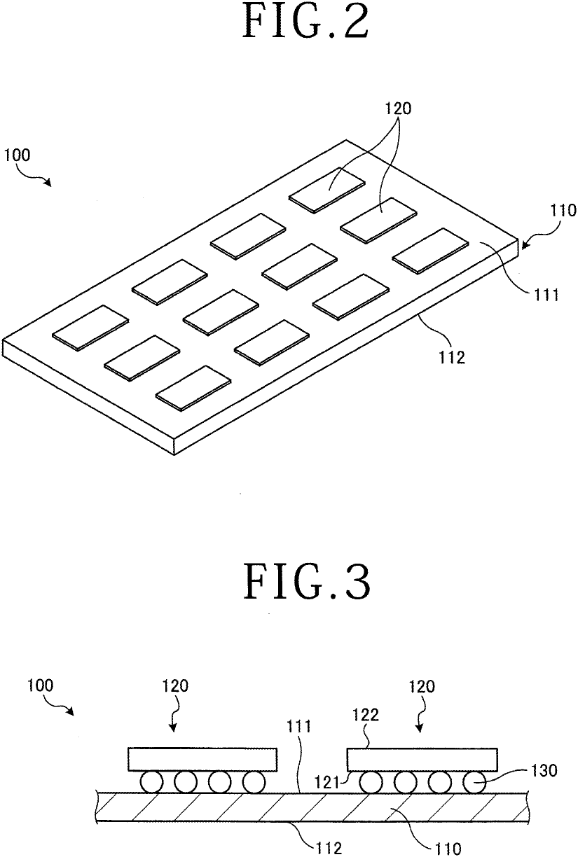

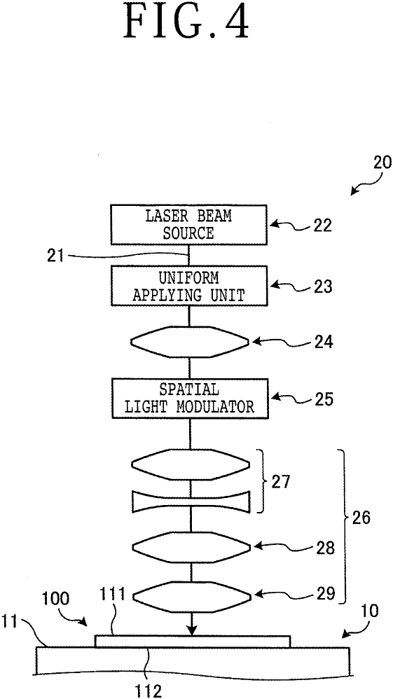

A laser beam applying apparatus 1 according to the preferred embodiment of the present invention will be described below with reference to the drawings. FIG. 1 illustrates in perspective a structural example of the laser beam applying apparatus 1 according to the present embodiment. FIG. 2 illustrates by way of example in perspective a plate-shaped workpiece 100 to be irradiated with a laser beam 21 by the laser beam applying apparatus 1 illustrated in FIG. 1. FIG. 3 illustrates the plate-shaped workpiece 100 illustrated in FIG. 2 in enlarged fragmentary cross section. FIG. 4 illustrates a structural example of an optical system of the laser beam applying apparatus 1 illustrated in FIG. 1. In the description that follows and FIG. 1, an X-axis direction refers to a direction extending along an X-axis in a horizontal plane, and a Y-axis direction refers to a direction extending along a Y-axis in the horizontal plane perpendicularly to the X-axis. A Z-axis refers to a direction extending along a Z-axis in a vertical plane perpendicularly to the X-axis and the Y-axis.

As illustrated in FIG. 1, the laser beam applying apparatus 1 according to the present embodiment includes a holding table 10, a laser beam applying unit 20, a moving mechanism 30, an image capturing unit 70, a display unit 80, and a controller 90. The laser beam applying apparatus 1 is an apparatus for applying the laser beam 21 (see FIG. 4) to the plate-shaped workpiece 100 (see FIGS. 2 and 3) that is held on the holding table 10.

According to the present embodiment, the plate-shaped workpiece 100 illustrated in FIGS. 2 and 3 includes a board 110 and a plurality of semiconductor chips 120 placed on the board 110 with bumps 130 interposed therebetween. The semiconductor chips 120 will be flip-chip mounted on the board 110 by reflowing the bumps 130 with the laser beam 21. Specifically, the laser beam applying apparatus 1 applies the laser beam 21 to the semiconductor chips 120 placed on the board 110 of the plate-shaped workpiece 100 held on the holding table 10, reflowing the bumps 130 to connect the semiconductor chips 120 to the board 110.

According to the present embodiment, the board 110 is of a rectangular shape. The board 110 is, for example, a printed circuit board (PCB), a device wafer to be divided into chips, or the like. The semiconductor chips 120 are disposed on a face side 111 of the board 110 with the bumps 130 interposed therebetween. The bumps 130 are disposed on a face side 121 of each of the semiconductor chips 120. The bumps 130 act as protrusive terminals disposed on the face side 121 of each of the semiconductor chips 120.

The semiconductor chips 120 are electrically connected to electrodes on the board 110 when the board 110 and the semiconductor chips 120 are heated to melt the bumps 130. According to the present embodiment, the plate-shaped workpiece 100 includes the semiconductor chips 120 arrayed on the board 110 with the bumps 130 interposed therebetween. However, the plate-shaped workpiece 100 may include a plurality of stacked semiconductor chips 120 with the bumps 130 interposed therebetween.

The holding table 10 illustrated in FIG. 1 holds the plate-shaped workpiece 100 on a holding surface 11 thereof. The holding surface 11 is shaped as a circular plate made of porous ceramic or the like and extends parallel to the horizontal plane. The holding surface 11 is fluidly connected to a vacuum suction source, not illustrated, through a vacuum suction channel, not illustrated. The holding table 10 holds the plate-shaped workpiece 100 under suction on the holding surface 11 by vacuum suction forces transmitted from the vacuum suction source through the vacuum suction channel.

The plate-shaped workpiece 100 where the semiconductor chips 120 are placed on the board 110 with the bumps 130 interposed therebetween is held on the holding table 10. At this time, the face sides 121 of the semiconductor chips 120 on which the bumps 130 are disposed face downwardly, and the bumps 130 on the face sides 121 are placed on the face side 111 of the board 110 which faces upwardly.

The holding table 10 is rotatable about a central axis parallel to the Z-axis by a rotating unit 13. The rotating unit 13 is supported on an X-axis movable plate 14. The rotating unit 13 and the holding table 10 are movable together with the X-axis movable plate 14 along the X-axis by an X-axis moving unit 40 of the moving mechanism 30. The rotating unit 13 and the holding table 10 are movable together with the X-axis movable plate 14, the X-axis moving unit 40, and a Y-axis movable plate 15 along the Y-axis by a Y-axis moving unit 50 of the moving mechanism 30.

The laser beam applying unit 20 applies the laser beam 21 to the plate-shaped workpiece 100 held on the holding table 10. As illustrated in FIG. 4, the laser beam applying unit 20 includes a laser beam source 22, a uniform applying unit 23, a light guide unit 24, a spatial light modulator (what is generally called an SLM) 25, and a beam focusing assembly 26.

The laser beam source 22 emits the laser beam 21. The laser beam source 22 includes a single light source having a fiber laser or a single laser diode (LD), a multiple light source having a plurality of LDs, or the like. The laser beam 21 emitted from the laser beam source 22 is of a continuous wave having a wavelength absorbable by the plate-shaped workpiece 100, i.e., the semiconductor chips 120.

The uniform applying unit 23 is disposed downstream of the laser beam source 22 with respect to the direction in which the laser beam 21 is emitted from the laser beam source 22. The uniform applying unit 23 acts to form a uniform irradiation plane through which the laser beam 21 emitted from the laser beam source 22 is applied to the spatial light modulator 25. In the uniform irradiation plane, the laser beam 21 has a uniform laser beam power density.

If the laser beam source 22 is a multiple light source, then the laser beam applying unit 20 should particularly include the uniform applying unit 23. Even if the laser beam source 22 is a single light source having a Gaussian intensity distribution, the laser beam applying unit 20 should particularly include the uniform applying unit 23 for providing a complete top hat intensity distribution. In addition, even if the laser beam source 22 has a top hat intensity distribution, the laser beam applying unit 20 should particularly include the uniform applying unit 23 for providing a more complete top hat intensity distribution.

The uniform applying unit 23 may be a combination of a collimator lens and an aspherical lens for providing a uniform irradiation plane, a combination of a collimator lens, a diffractive optical element (DOE), and a condensing lens for providing a uniform irradiation plane, a combination of a rod lens, i.e., a tubular member of glass, or a light pipe, i.e., a hollow tubular member surrounded by a mirror, called a homogenizer rod, and a light guide unit such as a relay lens or an optical fiber for providing a uniform irradiation plane, a combination of a collimator lens, first and second lens arrays each including an array of rod lens or a lens whose surface is shaped into an array of lenses, and a condensing lens for providing a uniform irradiation plane, or the like.

The light guide unit 24 is a unit for transferring the laser beam 21 from the uniform irradiation plane of the uniform applying unit 23 to the spatial light modulator 25. If the laser beam applying unit 20 does not include the uniform applying unit 23, then the light guide unit 24 transfers the laser beam 21 from the laser beam source 22 directly to the spatial light modulator 25. The light guide unit 24 includes an optical fiber and a relay lens, i.e., a combination lens, for example.

The spatial light modulator 25 is disposed between the laser beam source 22 and the beam focusing assembly 26. The spatial light modulator 25, which includes a spatial light modulating element, modulates the laser beam 21 emitted from the laser beam source 22, according to a phase pattern to be displayed, and emits the modulated laser beam 21. The spatial light modulator 25 modulates the laser beam 21 by controlling the spatial density distribution of the intensity, i.e., the power density, of the laser beam 21 emitted from the laser beam source 22.

The spatial light modulator 25 changes the position of an area of the plate-shaped workpiece 100 to be irradiated with the laser beam 21, by changing a phase pattern to be displayed. The spatial light modulator 25 is, for example, a known SLM device such as a reflective liquid-crystal-on-silicon (LCOS) device, a transmissive liquid crystal panel (LCP), a deformable mirror, or a digital micromirror device (DMD). According to the present embodiment, the spatial light modulator 25 is an LCOS device.

The beam focusing assembly 26 focuses the laser beam 21 applied thereto onto an irradiated surface of the plate-shaped workpiece 100. In the laser beam applying unit 20 according to the present embodiment, the beam focusing assembly 26 focuses the laser beam 21 onto an area of the plate-shaped workpiece 100 on the holding table 10, the area corresponding to a reverse side 122 of one of the semiconductor chips 120. Alternatively, the laser beam applying unit 20 may irradiate a plurality of semiconductor chips 120 with the laser beam 21. According to the present embodiment, the beam focusing assembly 26 includes a beam focusing system 27, a magnifying focusing lens 28, and a telecentric lens 29.

The beam focusing system 27 includes a single lens or a focusing lens made up of a combination lens. According to the example illustrated in FIG. 4, the beam focusing system 27 includes a biconvex lens and a biconcave lens arranged in an array. The beam focusing system 27 may be omitted if the spatial light modulator 25 includes a spatial light modulating element that doubles as a beam focusing system, i.e., a focusing lens.

The magnifying focusing lens 28 magnifies an image, i.e., a conjugate image, focused by the beam focusing system 27 and focuses the magnified image onto the irradiated surface of the plate-shaped workpiece 100. The magnifying focusing lens 28 may be dispensed with.

The telecentric lens 29 applies the laser beam 21 perpendicularly to the irradiated surface of the plate-shaped workpiece 100, i.e., applies the laser beam 21 parallel to the optical axis of the beam focusing assembly 26 to the irradiated surface of the plate-shaped workpiece 100. The beam focusing system 27 may be constructed as the telecentric lens 29, or the telecentric lens 29 may be omitted from the beam focusing assembly 26.

The moving mechanism 30 illustrated in FIG. 1 is a mechanism for moving the holding table 10 and the laser beam applying unit 20 relatively to each other. The moving mechanism 30 includes the X-axis moving unit 40, the Y-axis moving unit 50, and a Z-axis moving unit 60.

The X-axis moving unit 40 is a unit for moving the holding table 10 and the laser beam applying unit 20 relatively to each other along the X-axis. According to the present embodiment, the X-axis moving unit 40 moves the holding table 10 along the X-axis. According to the present embodiment, the X-axis moving unit 40 is installed on an apparatus body 2 of the laser beam applying apparatus 1.

The X-axis moving unit 40 supports the X-axis movable plate 14 for movement along the X-axis. According to the present embodiment, the X-axis moving unit 40 includes a known ball screw 41, a known stepping motor 42, and a pair of known guide rails 43. The ball screw 41 is rotatable about its central axis along the X-axis. The stepping motor 42, when energized, rotates the ball screw 41 about its central axis. The X-axis movable plate 14 is slidably supported on the guide rails 43 for movement along the X-axis. The guide rails 43 that are positioned one on each side of the ball screw 41 and extend along the X-axis are fixedly mounted on the Y-axis movable plate 15.

The Y-axis moving unit 50 is a unit for moving the holding table 10 and the laser beam applying unit 20 relatively to each other along the Y-axis. According to the present embodiment, the Y-axis moving unit 50 moves the holding table 10 along the Y-axis. According to the present embodiment, the Y-axis moving unit 50 is installed on the apparatus body 2 of the laser beam applying apparatus 1.

The Y-axis moving unit 50 supports the Y-axis movable plate 15 for movement along the Y-axis. According to the present embodiment, the Y-axis moving unit 50 includes a known ball screw 51, a known stepping motor 52, and a pair of known guide rails 53. The ball screw 51 is rotatable about its central axis along the Y-axis. The stepping motor 52, when energized, rotates the ball screw 51 about its central axis. The Y-axis movable plate 15 is slidably supported on the guide rails 53 for movement along the Y-axis. The guide rails 53 that are positioned one on each side of the ball screw 51 and extend along the Y-axis are fixedly mounted on the apparatus body 2.

The Z-axis moving unit 60 is a unit for moving the focused spot of the laser beam 21 that is focused by the beam focusing assembly 26 illustrated in FIG. 4, along the optical axis of the beam focusing assembly 26. The optical axis of the beam focusing assembly 26 extends along the Z-axis perpendicularly to the holding surface 11 of the holding table 10. The Z-axis moving unit 60 moves the holding table 10 and at least the beam focusing assembly 26 of the laser beam applying unit 20 relatively to each other along the Z-axis. According to the present embodiment, the Z-axis moving unit 60 is installed in an upstanding wall 3 on the apparatus body 2.

The Z-axis moving unit 60 supports at least the beam focusing assembly 26 of the laser beam applying unit 20 for movement along the Z-axis. According to the present embodiment, the Z-axis moving unit 60 includes a known ball screw 61, a known stepping motor 62, and a known guide rail 63. The ball screw 61 is rotatable about its central axis along the Z-axis. The stepping motor 62, when energized, rotates the ball screw 61 about its central axis. The laser beam applying unit 20 is slidably supported on the guide rail 63 for movement along the Z-axis. The guide rail 63 that is positioned alongside the ball screw 61 and extends along the Z-axis is fixedly mounted on the upstanding wall 3.

The image capturing unit 70 captures images of the plate-shaped workpiece 100 held on the holding surface 11 of the holding table 10. The image capturing unit 70 includes a charge-coupled-device (CCD) camera or an infrared camera for capturing images of the plate-shaped workpiece 100. The image capturing unit 70 is fixed to a housing of the laser beam applying unit 20 adjacent to the beam focusing assembly 26 (see FIG. 4). The image capturing unit 70 captures images of the plate-shaped workpiece 100 for use in an alignment process for positioning the plate-shaped workpiece 100 and the laser beam applying unit 20 with respect to each other, and outputs the captured images to the controller 90.

The display unit 80 is a display device including a liquid crystal display device or the like. The display unit 80 displays, for example, an image for setting processing conditions, a state of the plate-shaped workpiece 100 captured by the image capturing unit 70, a state of a processing operation, etc., on a display screen thereof. If the display screen of the display unit 80 includes a touch panel, then the display unit 80 may include an input device for accepting various manipulative actions performed by an operator of the laser beam applying apparatus 1 to register processing content information. The input device may alternatively be an external input device such as a keyboard. Information and images displayed on the display screen can be changed in response to manipulative actions accepted by the input device. The display unit 80 may also include a notifying device for emitting at least either sound or light to give predetermined notification information to the operator. The notifying device may alternatively be an external notifying device such as a speaker or a light emission device.

The controller 90 controls the components described above of the laser beam applying apparatus 1 to enable the laser beam applying apparatus 1 to perform various processing operations on the plate-shaped workpiece 100. Specifically, the controller 90 controls the laser beam applying unit 20, the moving mechanism 30, the image capturing unit 70, and the display unit 80. The controller 90 is a computer including a processing device as calculating means, a storage device as storing means, and an input/output interface device as communicating means. The processing device includes a microprocessor such as a central processing unit (CPU). The storage device has a memory such as a read only memory (ROM) or a random access memory (RAM). The processing device performs various calculating processes according to predetermined programs stored in the storage device. The processing device outputs various control signals through the input/output interface device to the components of the laser beam applying apparatus 1 according to the results of the calculating processes, thereby controlling the laser beam applying apparatus 1. The controller 90 has a phase pattern storage section 91 and a phase pattern control section 92.

The phase pattern storage section 91 stores a plurality of phase patterns. When the phase patterns stored in the phase pattern storage section 91 are displayed on the spatial light modulator 25, the phase patterns represent respective different positions in the plane of the plate-shaped workpiece 100 where the laser beam 21 is applied. Specifically, when the phase patterns are displayed on the spatial light modulator 25, the positions where the laser beam 21 is applied as represented by the phase patterns indicate respective regions corresponding to the different semiconductor chips 120 on the board 110.

The phase pattern control section 92 successively switches to predetermined phase patterns among the phase patterns stored in the phase pattern storage section 91 as the phase patterns displayed on the spatial light modulator 25 in order to change the positions in the plane of the plate-shaped workpiece 100 where the laser beam 21 is applied. When the phase pattern control section 92 switches to those predetermined phase patterns to be displayed on the spatial light modulator 25, the laser beam 21 two-dimensionally scans the plane of the plate-shaped workpiece 100. More specifically, when the phase pattern control section 92 successively switches to those predetermined phase patterns to be displayed on the spatial light modulator 25 as indicating the respective regions corresponding to the different semiconductor chips 120 on the board 110, the laser beam 21 two-dimensionally scans the regions corresponding to the different semiconductor chips 120 in the plane of the board 110, reflowing the bumps 130 included in the area irradiated with the laser beam 21.

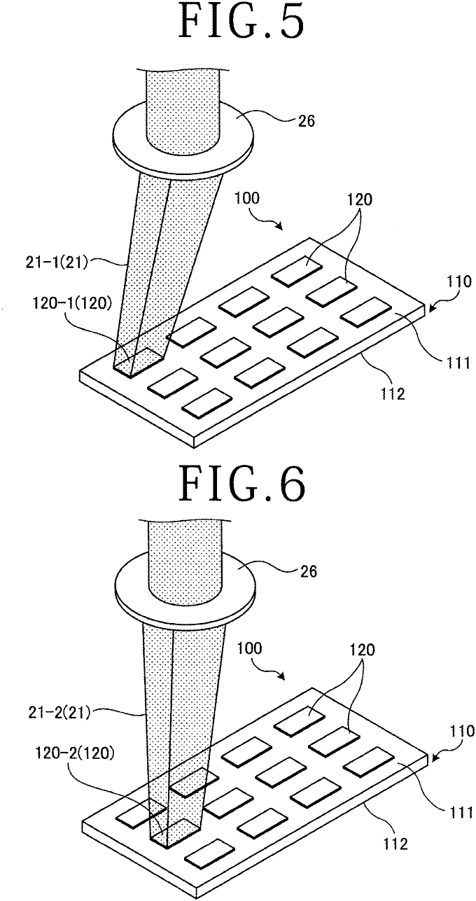

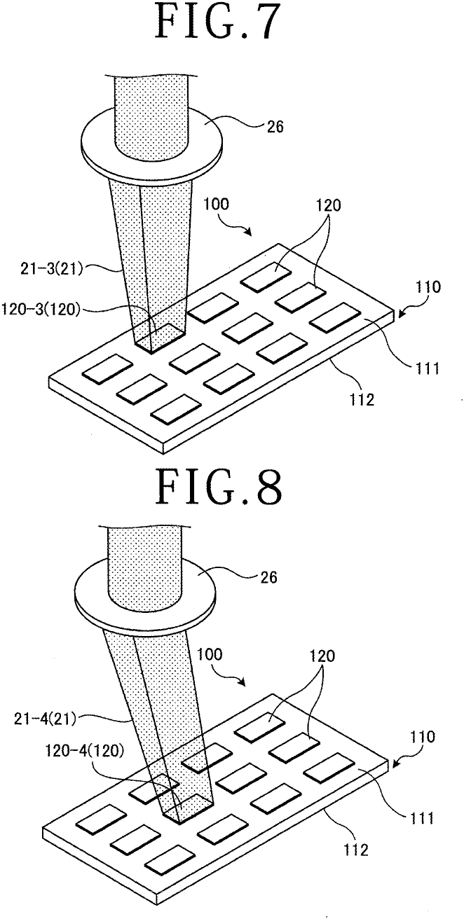

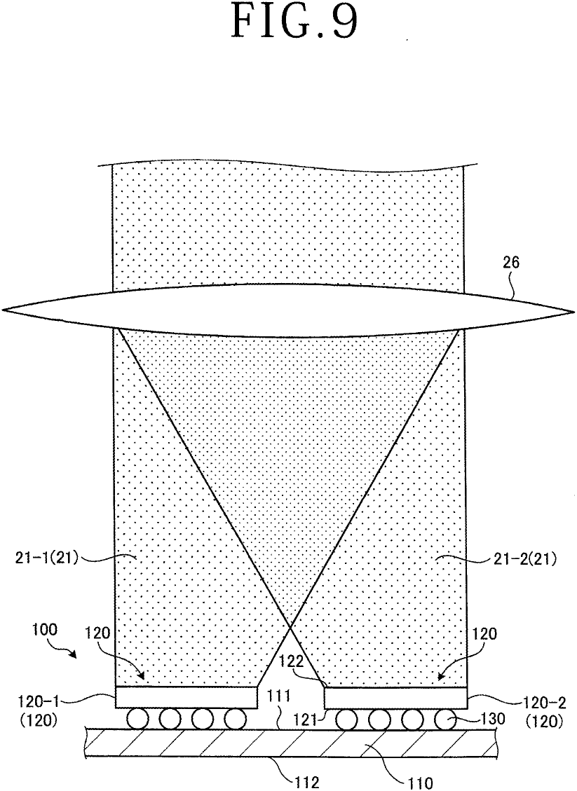

A process carried out by the laser beam applying apparatus 1 for applying the laser beam 21 to the plate-shaped workpiece 100 whose reverse side 112 is held on the holding table 10, thereby reflowing the bumps 130 will be described below. FIG. 5 illustrates in perspective the manner in which a laser beam 21-1 modulated by a first phase pattern is focused onto the plate-shaped workpiece 100. FIG. 6 illustrates in perspective the manner in which a laser beam 21-2 modulated by a second phase pattern is focused onto the plate-shaped workpiece 100. FIG. 7 illustrates in perspective the manner in which a laser beam 21-3 modulated by a third phase pattern is focused onto the plate-shaped workpiece 100. FIG. 8 illustrates in perspective the manner in which a laser beam 21-4 modulated by a fourth phase pattern is focused onto the plate-shaped workpiece 100. FIG. 9 illustrates the plate-shaped workpiece 100 illustrated in FIGS. 5 and 6, in enlarged fragmentary cross section.

First, the laser beam applying apparatus 1 operates to enable the spatial light modulator 25 of the laser beam applying unit 20 to display the first phase pattern. The first phase pattern is a phase pattern to modulate the laser beam 21 such that the area irradiated with the modulated laser beam 21-1 illustrated in FIG. 5 represents a region corresponding to a semiconductor chip 120-1.

Then, the laser beam applying apparatus 1 applies the laser beam 21 to the plate-shaped workpiece 100 from the face side 111 of the board 110. The laser beam 21-1 modulated by the first phase pattern is applied to the surface, i.e., the reverse side 122, of the semiconductor chip 120-1, the surface being opposite the other surface, i.e., the face side 121, thereof on which the bumps 130 are present. At this time, since the area irradiated with the modulated laser beam 21-1 represents the region corresponding to the semiconductor chip 120-1, the bumps 130 beneath the semiconductor chip 120-1 in its entirety are reflowed by the laser beam 21-1, connecting the semiconductor chip 120-1 to the board 110. The laser beam applying apparatus 1 applies the laser beam 21 to one semiconductor chip 120 for one second, for example.

Next, the laser beam applying apparatus 1 operates to switch from the first phase pattern to the second phase pattern to be displayed on the spatial light modulator 25. The period of time required for the laser beam applying apparatus 1 to switch from one phase pattern to another is approximately 30 milliseconds, for example. The second phase pattern is a phase pattern to modulate the laser beam 21 such that the area irradiated with the modulated laser beam 21-2 illustrated in FIG. 6 represents a region corresponding to a semiconductor chip 120-2.

The area irradiated with the laser beam 21 thus switches from the region corresponding to the semiconductor chip 120-1 to the region corresponding to the semiconductor chip 120-2. The laser beam 21-2 modulated by the second phase pattern is applied to the surface, i.e., the reverse side 122, of the semiconductor chip 120-2, the surface being opposite the other surface, i.e., the face side 121, thereof on which the bumps 130 are present. The bumps 130 beneath the semiconductor chip 120-2 in its entirety are reflowed by the laser beam 21-2, connecting the semiconductor chip 120-2 to the board 110.

Similarly, the laser beam applying apparatus 1 operates to switch from the second phase pattern to the third phase pattern to be displayed on the spatial light modulator 25. The third phase pattern is a phase pattern to modulate the laser beam 21 such that the area irradiated with the modulated laser beam 21-3 illustrated in FIG. 7 represents a region corresponding to a semiconductor chip 120-3.

The area irradiated with the laser beam 21 thus switches from the region corresponding to the semiconductor chip 120-2 to the region corresponding to the semiconductor chip 120-3. The laser beam 21-3 modulated by the third phase pattern is applied to the surface, i.e., the reverse side 122, of the semiconductor chip 120-3, the surface being opposite the other surface, i.e., the face side 121, thereof on which the bumps 130 are present. The bumps 130 beneath the semiconductor chip 120-3 in its entirety are reflowed by the laser beam 21-3, connecting the semiconductor chip 120-3 to the board 110.

Similarly, the laser beam applying apparatus 1 operates to switch from the third phase pattern to the fourth phase pattern to be displayed on the spatial light modulator 25. The fourth phase pattern is a phase pattern to modulate the laser beam 21 such that the area irradiated with the modulated laser beam 21-4 illustrated in FIG. 8 represents a region corresponding to a semiconductor chip 120-4.

The area irradiated with the laser beam 21 thus switches from the region corresponding to the semiconductor chip 120-3 to the region corresponding to the semiconductor chip 120-4. The laser beam 21-4 modulated by the fourth phase pattern is applied to the surface, i.e., the reverse side 122, of the semiconductor chip 120-4, the surface being opposite the other surface, i.e., the face side 121, thereof on which the bumps 130 are present. The bumps 130 beneath the semiconductor chip 120-4 in its entirety are reflowed by the laser beam 21-4, connecting the semiconductor chip 120-4 to the board 110.

In this manner, while the laser beam 21 is being applied to the plate-shaped workpiece 100, the laser beam applying apparatus 1 switches from one phase pattern to another, successively shifting the area irradiated with the laser beam 21 to different regions in the plane of the board 110. Stated otherwise, as illustrated in FIG. 9, in a range that can be irradiated with the laser beam 21, the angle at which the laser beam 21 is applied to the plate-shaped workpiece 100 is changed by the phase patterns, causing the laser beam 21 to two-dimensionally scan the plate-shaped workpiece 100 in its plane.

As described above, the laser beam applying apparatus 1 according to the present embodiment switches from one phase pattern to another by using the spatial light modulator 25 to change the angle at which the laser beam 21 is applied to the plate-shaped workpiece 100, causing the laser beam 21 to two-dimensionally scan the plate-shaped workpiece 100 from one irradiated area to another. Therefore, the laser beam applying apparatus 1 can maintain a required laser beam power density and realize a relatively simple apparatus structure without the need for separate scanning means.

Further, since the period of time required for the spatial light modulator 25 to switch from one phase pattern to another is much shorter than if the holding table 10 and the beam focusing assembly 26 for focusing the laser beam 21 onto the plate-shaped workpiece 100 are physically moved, the laser beam applying apparatus 1 contributes to an increased level of productivity. The period of time required to move the holding table 10 is approximately one second, for example, whereas the period of time required to switch from one phase pattern to another is approximately 30 milliseconds, for example.

Specifically, if the laser beam 21 is applied successively to four semiconductor chips 120 as illustrated in FIGS. 5 through 8, then, when the holding table 10 is moved to switch between the semiconductor chips 120 and the laser beam 21 is applied to them one at a time, a total period of time required is eight seconds as four seconds are required to move the holding table 10 and one second is required to apply the laser beam 21 to each of the semiconductor chips 120. According to the present embodiment, by contrast, a total period of time required is four seconds as 120 milliseconds are required to switch between the phase patterns and one second is required to apply the laser beam 21 to each of the semiconductor chips 120.

The present invention is not limited to the embodiment described above. Various changes and modifications may be made in the embodiment without departing from the scope of the invention.

For example, if the region of the plate-shaped workpiece 100 to be irradiated with the laser beam 21 is larger than the area that can be irradiated by the spatial light modulator 25, then the laser beam 21 is applied to the area, i.e., a first irradiatable area, that can be irradiated by the spatial light modulator 25 through switching between the phase patterns at a given position, after which the plate-shaped workpiece 100 is moved to another position by the moving mechanism 30, and then the laser beam 21 is applied to the area, i.e., a second irradiatable area, that can be irradiated by the spatial light modulator 25 through switching between the phase patterns again. Consequently, even if the region of the plate-shaped workpiece 100 to be irradiated with the laser beam 21 is too large for the spatial light modulator 25, the laser beam 21 can efficiently be applied to the plate-shaped workpiece 100 to reflow the bumps 130.

One phase pattern is not limited to the application of the laser beam 21 to one semiconductor chip 120, and may be applicable to the application of the laser beam 21 to a plurality of semiconductor chips 120.

According to the illustrated embodiment, the beam focusing assembly 26 includes the beam focusing system 27, the magnifying focusing lens 28, and the telecentric lens 29 that are separate from the spatial light modulator 25. However, the beam focusing assembly 26 may be provided by a focusing function of the spatial light modulator 25.

The present invention is not limited to the details of the above described preferred embodiment. The scope of the invention is defined by the appended claim and all changes and modifications as fall within the equivalence of the scope of the claim are therefore to be embraced by the invention.

What is claimed is:

1. A laser beam applying apparatus comprising:
a holding table for holding a plate-shaped workpiece thereon;
a laser beam applying unit for applying a laser beam to the plate-shaped workpiece held on the holding table; and
a controller for controlling the laser beam applying unit,
wherein the laser beam applying unit includes
a laser beam source for emitting the laser beam,
a spatial light modulator for modulating the laser beam emitted from the laser beam source, according to phase patterns, and emitting the modulated laser beam, and
a beam focusing assembly for focusing the laser beam modulated by the spatial light modulator and applying the focused laser beam to the plate-shaped workpiece,
the controller includes
a phase pattern storage section for storing a plurality of phase patterns representing respective different positions in a plane of the plate-shaped workpiece where the laser beam is applied when the phase patterns are displayed on the spatial light modulator, and
a phase pattern control section for switching to predetermined phase patterns among the phase patterns stored in the phase pattern storage section as the phase patterns displayed on the spatial light modulator, and
wherein the laser beam is able to two-dimensionally scan the plane of the plate-shaped workpiece when the phase pattern control section switches between the phase patterns displayed on the spatial light modulator.

2. The laser beam applying apparatus according to claim 1, further comprising:
a moving mechanism for moving the holding table and a focused spot of the laser beam relatively to each other.

3. The laser beam applying apparatus according to claim 1,
wherein the plate-shaped workpiece includes a board with a plurality of semiconductor chips mounted thereon with bumps interposed between the board and a surface of each of the semiconductor chips, and
the phase patterns stored in the phase pattern storage section include phase patterns such that, when the phase patterns are displayed on the spatial light modulator, the positions where the laser beam is applied as represented by the phase patterns indicate respective regions corresponding to the semiconductor chips on the board, and
the laser beam is able to two-dimensionally scan a plane of the board in regions corresponding to the semiconductor chips to reflow the bumps included in areas irradiated with the laser beam, when the phase pattern control section switches between the phase patterns displayed on the spatial light modulator.

4. The laser beam applying apparatus according to claim 1, wherein the beam focusing assembly is provided by a focusing function of the spatial light modulator.
